(19) United States
(12) Patent Application Publication
(10) Pub. No.: US 2009/0161762 A1
(43) Pub. Date: Jun. 25, 2009

(54) METHOD OF SCALABLE VIDEO CODING FOR VARYING SPATIAL SCALABILITY OF BITSTREAM IN REAL TIME AND A CODEC USING THE SAME

(76) Inventors: Dong-San Jun, Chungcheongnam-do (KR); Jung Won Kang, Seoul (KR); Yong-Ju Cho, Daejeon-city (KR); Jae Gon Kim, Daejeon-city (KR); Jin Woo Hong, Daejeon-city (KR); Yong Man Ro, Daejeon-city (KR); Tae Meon Bae, Daegu-city (KR); Duck-Yeon Kim, Pohang-city (KR); Hae-Chul Choi, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 12/093,611

(22) PCT Filed: Nov. 15, 2006
(86) PCT No.: PCT/KR06/04809

§ 371 Date: Sep. 17, 2008

(30) Foreign Application Priority Data
Nov. 15, 2005 (KR) 10-2005-0109235
Jan. 11, 2006 (KR) 10-2006-0002967
Nov. 15, 2006 (KR) 10-2006-0112777

(51) Int. Cl. H04N 7/26

(52) U.S. Cl. 375/240.16; 375/E07.078; 375/E07.104

(57) ABSTRACT

Methods of coding a bitstream in which the frames are encoded for enabling a spatial resolution is changed in real time, extracting the bitstream by adding a signaling message indicating that the spatial resolution is changed, and decoding the bitstream in which the spatial resolution is changed in real time after actively detects whether the spatial resolution is changed without additional information, and a codec using the methods are provided. Therefore, if the network has the restricted environment that the resolution is changed in real time while a video encoding and decoding or if there is a need to output the video whose the spatial resolution is partly changed in the decoder, the present invention provides methods to actively cope with the spatial resolution change of the video so as to efficiently watch the video.

### TECHNICAL FIELD

The present invention relates to a scalable video coding (SVC) method which can change the spatial resolution of a bitstream in real-time and a codec using the same, and more particularly, to a SVC method including generating a bitstream by designating a starting point for indexing a resolution change, extracting the bitstream after inserting resolution change information prior to the starting point, and decoding the bitstream while changing the spatial resolution of the bitstream including a Coarse Granular Scalability (CGS) layer in real-time, and a codec using the method.

### BACKGROUND ART

A Joint Video Team (JVT) of the Video Coding Experts Group (VCEG) has expanded Motion Compensated Temporal Filtering (MCTF) and H.264 to support a Scalable Video Coding (SVC) standard. The currently standardized SVC (ITU-T and ISO/IEC JTC1, “scalable Video Coding—Working Draft 2” JVT-0201, April 2005) provides bitstreams having spatial scalability, temporal scalability, and quality scalability and removes a specific section of a bitstream coded according to a user's terminal and a network state, which allows bitstream having different spatial, temporal, and quality scalabilities to be formed. A device extracting a bitstream in which scalability thereof is changed from the coded scalable video bitstream is called a bitstream extractor.

A scalable video coding method codes a bitstream into a layer structure and controls the resolution of a video, a frame rate, and a Signal-to-Noise Ratio (SNR) according to a circumferential condition such as a transmission bit rate, a transmission error rate, the type of terminal and a network state, and thereby decodes the bitstream only to an appropriate extent.

### DESCRIPTION OF THE DRAWINGS

The above and other aspects and advantages of the present invention will become more apparent by describing in detail exemplary embodiments thereof with reference to the attached drawings in which:

FIG. 1 is a flow chart illustrating a scalable video encoding method according to an embodiment of the present invention;

FIG. 2 is a flow chart illustrating a scalable video encoding method according to another embodiment of the present invention;

FIG. 3 is a flow chart illustrating a method of extracting a bitstream whose spatial resolution is changed from a coded scalable video bitstream according to an embodiment of the present invention;

FIG. 4 is a diagram illustrating the syntax of Supplemental Enhancement Information (SEI) named Valid_seq_parameter_set_info (or Seq_parameter_set_for_CurrPic) as an example of metadata indicating spatial resolution change information inserted in an extractor according to an embodiment of the present invention;

FIG. 5 is a diagram illustrating the syntax of Network Abstraction Layer (NAL) named end_of_sequence as another example of metadata indicating spatial resolution change information inserted in an extractor according to an embodiment of the present invention;

FIG. 6 is a flow chart illustrating a scalable video decoding method which decodes a bitstream by extracting spatial resolution change information according to an embodiment of the present invention;

FIG. 7 is a flow chart illustrating a scalable video decoding method which actively detects whether the spatial resolution is changed so as to decode the bitstream according to an embodiment of the present invention;

FIG. 8 is a flow chart illustrating a scalable video decoding method which actively detects whether the spatial resolution is changed so as to decode the bitstream according to another embodiment of the present invention;

FIG. 9 is a diagram of pseudo code illustrating a scalable video decoding method which actively detects whether the spatial resolution is changed so as to decode the bitstream according to an embodiment of the present invention;

FIG. 10 is a diagram of pseudo code which renews resolution and a reconstruction layer of an output image in the access unit including an Instantaneous Decoder Refresh (IDR) frame according to an embodiment of the present invention;

FIG. 11 is a flow chart illustrating a scalable video decoding method illustrating a method of estimating the motion of a bitstream whose a spatial resolution is changed according to an embodiment of the present invention;

FIG. 12 is a conceptual diagram of a scalable video decoding method based on a Subordinate Layer Reusing (SLR) technique according to an embodiment of the present invention;

FIG. 13 is a flow chart illustrating a scalable video coding method which can change spatial resolution of the bitstream in real time according to an embodiment of the present invention;

FIG. 14 is a flow chart illustrating a scalable video coding method which can change spatial resolution of the bitstream in real time by actively detecting whether the resolution is changed, according to an embodiment of the present invention;

FIG. 15 is a block diagram of a scalable video encoder according to an embodiment of the present invention;

FIG. 16 is a block diagram of an extractor which extracts from a coded bitstream a bitstream whose resolution is changed, according to an embodiment of the present invention;

FIG. 17 is a block diagram of a scalable video decoder which extracts spatial resolution change information from the bitstream whose resolution is changed so as to decode the bitstream according to an embodiment of the present invention;

FIG. 18 is a block diagram of a scalable video decoder which actively detects whether the spatial resolution is changed in the bitstream whose spatial resolution is changed so as to decode the bitstream according to an embodiment of the present invention;

FIG. 19 is a block diagram of a scalable video decoder which actively detects whether the resolution is changed in the bitstream, so as to decode the bitstream according to another embodiment of the present invention;

FIG. 20 is a block diagram of a scalable video decoder which decodes a bitstream using a Subordinate Layer Reusing (SLR) technique according to an embodiment of the present invention; and

FIG. 21 is a block diagram of a codec enabling the spatial resolution of a bitstream to be changed in real time according to an embodiment of the present invention.

### DETAILED DESCRIPTION OF THE INVENTION

### Technical Problem

Conventional methods cannot properly cope with an environment in which traffic of the network is changed frequently such as an internet network or a wireless network. In order to guarantee the quality of a streaming service, a scalable video coding method and a codec are needed to respond adaptively to the network status.

### Technical Solution

The present invention provides a scalable video bitstream encoding method for enabling a scalable video bitstream to be decoded while changing a spatial resolution of the scalable video bitstream in real time and an encoder using the same.

The present invention also provides method of extracting a bitstream in which the spatial resolution of the bitstream is changed in real time through a specific process and signaling so that a decoder identifies that the spatial resolution gets increased or reduced in the bitstream, and an extractor using the same.

The present invention also provides method of actively detecting whether the spatial resolution (that is a spatial layer) has changed in a bitstream, when the extractor does not provide signaling indicating the spatial resolution change, and a decoder using the same.

The present invention also provides coding method of generating an encoded bitstream for enabling the bitstream to be decoded while changing a spatial resolution in real time, extracting a bitstream while changing the spatial resolution in real time from the encoded bitstream and while adding a signaling message indicating that the spatial resolution has changed, and actively detecting whether the spatial resolution has changed without additional information so as to decode the bitstream in which the spatial resolution is changed in real time, and a codec using the same.

### Advantageous Effects

In the present invention, an initial point which can change spatial resolution during encoding is limited to the key frame of the GOP and the frame is coded into the IDR frame and the intra frame to generate a scalable video bitstream. Therefore, the spatial resolution is changed in real time during decoding.

In addition, in the present invention, SEI metadata indicating that the spatial resolution is changed is defined and spatial resolution change information of the metadata is inserted into the bitstream in the bitstream extractor. Therefore, whether the spatial resolution is increased or reduced can be identified through information in the SEI message by the decoder to perform decoding and thus the bitstream in which the spatial resolution is changed in real time can be decoded.

If the SEI information is not inserted into the bitstream in the extractor, the decoder actively searches the dependency_id of the NAL unit from the bitstream in which the spatial resolution is changed in real time to detect the spatial resolution change and thus spatial resolution can be changed and decoded in real time.

In addition, if the spatial resolution change information such as the SEI or end of sequence information does not exist, the decoder actively detects whether the spatial resolution changes and uses the SLR technique for decoding, thereby changing the spatial resolution and decoding in real time.

Moreover, while decoding using the SLR method as described above, an enhancement layer is coded (INTRA_BL mode+Intra prediction in cur. layer) into the intra frame in a predetermined period and thus error propagation can be prevented.

Therefore, if the network has the restricted environment that the resolution is changed in real time while video encoding and decoding or if there is a need to output the video whose spatial resolution is partly changed in the decoder, the present invention provides methods to actively cope with the spatial resolution change of the video so as to efficiently watch the video.

Except that the size of the image is increased, the CGS layer is treated same with the case of increasing the spatial resolution and thus the CGS of the upper layer is treated as the layer of the upper spatial resolution and the CGS of the lower layer is treated as the layer of the lower spatial resolution. Therefore, the method and the apparatus can be applied to the CGS layer.

### BEST MODE OF THE INVENTION

According to an aspect of the present invention, there is provided a scalable video encoding method for performing a motion estimation to each key frame which distinguishes each of Groups of Pictures (GOPs) with reference to a key frame previously inputted and for generating a bitstream which can be decoded while a spatial resolution is changed in real time, the method comprising: designating the key frame of the GOP which corresponds to a location at which the spatial resolution is to be changed as an initial point from which spatial resolution is changed; and encoding the key frame that is designated as the initial point into an IDR frame and an intra frame.

According to another aspect of the present invention, there is provided a scalable video encoding method for performing a motion estimation to each key frame which distinguishes each of Groups of Pictures (GOPs) with reference to a key frame previously inputted and for generating a bitstream which can be decoded while a spatial resolution is changed in real time, the method comprising: when the frames inputted in a GOP unit are encoded into the IDR frame in a first periodic interval, encoding the frames into the intra frame in a second periodic interval which is shorter than the first periodic interval; and when the frames inputted in a GOP unit are not encoded into the IDR frame in a first periodic interval, encoding the frames into the intra frame in a third periodic interval.

According to another aspect of the present invention, there is provided a method of extracting from an encoded scalable bitstream a scalable video bitstream whose spatial resolution is changed, the method comprising: when the spatial resolution is to be reduced, selecting a NAL unit which is related to reduction of the spatial resolution from the corresponding temporal location; when the spatial resolution is to be increased, searching the key frame which is designated as an initial point from which spatial resolution is changed among key frames which distinguish each of GOPs of the encoded scalable video bitstream and coded into an IDR frame and an intra frame; and selecting a NAL unit which is related to an increase of the spatial resolution from the key frame obtained by the searching.

According to another aspect of the present invention, there is provided a scalable video decoding method for performing a motion estimation to each key frame which distinguishes each of Groups of Pictures (GOPs) with reference to a key frame previously inputted and for decoding a bitstream while changing a spatial resolution in real time, the method comprising: identifying whether a key frame of currently inputted GOP is designated as an initial point from which spatial resolution is changed and whether the key frame is encoded into an intra frame and IDR frame; when the key frame is the intra frame and the IDR frame, extracting spatial resolution change information inserted prior to a NAL unit of the key frame that is designated as the initial point; and determining the spatial resolution to be outputted from the spatial resolution change information.

According to another aspect of the present invention, there is provided a scalable video decoding method for performing a motion estimation to each key frame which distinguishes each of Groups of Pictures (GOPs) with reference to a previously inputted key frame and for decoding a bitstream while changing a spatial resolution in real time, the method comprising: searching an IDR frame in the bitstream inputted in a GOP unit; identifying the maximum dependency id of a current access unit formed of the IDR frame; and comparing the maximum dependency id of the current access unit with the maximum dependency id of a previous access unit formed of the IDR frame to determine whether the spatial resolution of the current access unit is changed.

According to another aspect of the present invention, there is provided a scalable video decoding method for performing a motion estimation to each key frame which distinguishes each of Groups of Pictures (GOPs) with reference to a previously inputted key frame and for decoding a bitstream while changing a spatial resolution in real time, the method comprising: identifying the maximum dependency id of currently inputted GOP; and comparing the maximum dependency id of the current GOP with the maximum dependency id of previous GOP to determine whether the spatial resolution of the current GOP is changed.

According to another aspect of the present invention, there is provided a scalable video decoding method for performing a motion estimation to each key frame which distinguishes each of Groups of Pictures (GOPs) with reference to a previously inputted key frame and for decoding a bitstream while changing a spatial resolution in real time, the method comprising: determining whether the spatial resolution of a GOP currently inputted is changed; when the spatial resolution of the current GOP is increased, up-sampling the key frame of a lower layer which corresponds to a temporally identical location with the key frame of a GOP previously inputted of the layer which is same with layer of the current GOP; and performing the motion estimation by the key frame of the current GOP with reference to the key frame of the lower layer that is up-sampled.

According to another aspect of the present invention, there is provided a scalable video coding method for performing a motion estimation to each key frame which distinguishes each of Groups of Pictures (GOPs) with reference to a previously inputted key frame, the method comprising: designating the key frame of the GOP which corresponds to a location for a spatial resolution to be changed as an initial point of the spatial resolution changing and encoding the key frame into an IDR frame and intra frame to generate a bitstream which can be decoded while the spatial resolution is changed in real time; inserting spatial resolution change information prior to a NAL unit of the frame in which the spatial resolution is changed in the bitstream and extracting the bitstream whose spatial resolution is changed; and decoding the bitstream whose spatial resolution is changed while the spatial resolution is changed in real time based on the spatial resolution change information.

According to another aspect of the present invention, there is provided a scalable video coding method for performing a motion estimation to each key frame which distinguishes each of Groups of Pictures (GOPs) with reference to a previously inputted key frame, the method comprising: encoding the frames inputted in a GOP unit into an intra frame in a predetermined periodic interval and generating a bitstream; identifying the maximum dependency id of each GOP in the encoded bitstream to detect whether spatial resolution is changed; and when it is determined that the spatial resolution is increased, decoding the key frame of the GOP in which the spatial resolution is increased with reference to the key frame of a lower layer.

According to another aspect of the present invention, there is provided a scalable video encoder to perform a motion estimation to each key frame which distinguishes each of Groups of Pictures (GOPs) with reference to a previously inputted key frame and to generate a bitstream which can be decoded while a spatial resolution is changed in real time, the encoder comprising: a point designating unit which designates the key frame of the GOP which corresponds to a location at which the spatial resolution is changed as an initial point from which spatial resolution is changed; and an encoding unit which encodes the key frame that is designated as the initial point into an IDR frame and intra frame.

According to another aspect of the present invention, there is provided a scalable video encoder to perform a motion estimation to each key frame which distinguishes each of Groups of Pictures (GOPs) with reference to a previously inputted key frame and to generate a bitstream which can be decoded while a spatial resolution is changed in real time, the encoder comprising: an encoding unit which encodes the frames inputted in a GOP unit into an intra frame in a second periodic interval which is shorter than a first periodic interval, when the frames inputted in a GOP unit are encoded into an IDR frame in the first periodic interval, and which encodes the frames inputted in a GOP unit into an intra frame in a third periodic interval, when the frames inputted in a GOP unit are not encoded into the IDR frame in a first periodic interval.

According to another aspect of the present invention, there is provided a bitstream extractor to extract a bitstream whose spatial resolution is changed in a encoded scalable video bitstream, the extractor comprising: a key frame searching unit which searches the key frame designated as an initial point from which spatial resolution is changed among the key frames distinguishing each GOP in the encoded scalable video bitstream and encoded into an IDR frame and intra frame, when the spatial resolution is to be increased; and a NAL unit selecting unit which selects the NAL unit which is related to increase of the spatial resolution from the key frame obtained by the searching and selects the NAL unit which is related to reduction of the spatial resolution from a corresponding temporal location when the spatial resolution is to be reduced.

According to another aspect of the present invention, there is provided a scalable video decoder to perform a motion estimation to each key frame which distinguishes each of Groups of Pictures (GOPs) with reference to a previously inputted key frame and to decode a bitstream while changing a spatial resolution in real time, the decoder comprising: a key frame identifying unit which identifies whether the key frame of the GOP currently inputted is designated as an initial point from which spatial resolution is changed and whether the key frame is coded into an intra frame and IDR frame; an information extracting unit which extracts spatial resolution change information inserted prior to a NAL unit of the key frame designated as the initial point, when the key frame is the intra frame and the IDR frame; and a resolution determining unit which determines the spatial resolution to be outputted from the spatial resolution change information.

According to another aspect of the present invention, there is provided a scalable video decoder to perform a motion estimation to each key frame which distinguishes each of Groups of Pictures (GOPs) with reference to a previously inputted key frame and to decode a bitstream while changing a spatial resolution in real time, the decoder comprising: a key frame searching unit which searches an IDR frame in the bitstream inputted in a GOP unit; an id identifying unit which identifies the maximum dependency id of the current access unit formed of the IDR frame; and a determining unit which compares the maximum dependency id of the current access unit with the maximum dependency id of the access unit formed of the previously inputted IDR frame and determines whether the spatial resolution of the current access unit is changed.

According to another aspect of the present invention, there is provided a scalable video decoder to perform a motion estimation to each key frame which distinguishes each of Groups of Pictures (GOPs) with reference to a previously inputted key frame, the decoder comprising: an id identifying unit which identifies the maximum dependency id of a GOP currently inputted; and a determining unit which compares the maximum dependency id of the current GOP with the maximum dependency id of the previous GOP and determines whether the spatial resolution of the current GOP is changed.

According to another aspect of the present invention, there is provided a scalable video decoder to perform a motion estimation to each key frame which distinguishes each of Groups of Pictures (GOPs) with reference to a previously inputted key frame, the decoder comprising: a determining unit which determines whether the spatial resolution of a GOP currently inputted is changed; an up-sampling unit which up-samples the key frame of a lower layer which corresponds to a temporally identical location with the key frame of the previous GOP of the layer which is same with the layer of the current GOP; and a motion estimation unit in which the motion estimation is performed by the key frame of the current GOP with reference to the key frame of the lower layer that is up-sampled.

According to another aspect of the present invention, there is provided a scalable video codec to perform a motion estimation to each key frame which distinguishes each of Groups of Pictures (GOPs) with reference to a previously inputted key frame, the codec comprising: an encoder which designates the key frame of the GOP corresponding to a location for the spatial resolution to be changed as an initial point from which spatial resolution is changed, encodes the key frame into an IDR frame and intra frame, and generates the bitstream so that the bitstream can be decoded while a spatial resolution is changed in real time; a bitstream extractor which extracts the bitstream in which the spatial resolution is changed while inserting the spatial resolution change information prior to a NAL unit of the frame in which the spatial resolution is changed in the bitstream; and a decoder which decodes the bitstream in which the spatial resolution is changed while a spatial resolution of the bitstream is changed in real time based on spatial resolution change information.

According to another aspect of the present invention, there is provided a scalable video codec to perform a motion estimation to each key frame which distinguishes each of Groups of Pictures (GOPs) with reference to a previously inputted key frame, the codec comprising: an encoder which encodes a frames inputted in a GOP unit into an intra frame in a predetermined periodic interval and generates a bitstream; a resolution change detecting unit which identifies the maximum dependency id in a GOP unit in the encoded bitstream to detect whether the spatial resolution is changed; and a decoder which decodes the key frame of the GOP in which the spatial resolution is increased with reference to a key frame of a lower layer, when it is determined that the spatial resolution is increased.

According to another aspect of the present invention, there is provided a computer readable medium having embodied thereon a computer program for the method of scalable video coding which can be decoded while a spatial resolution of the bitstream is changed in real time.

### Mode for Invention

Hereinafter, the present invention will be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, like reference numerals denote like elements, and the sizes and thicknesses of layers and regions are exaggerated for clarity. Also, the terms used herein are defined according to the functions of the present invention. Thus, the terms may vary depending on users or operators and usages. That is, the terms used herein must be understood based on the descriptions made herein.

Features of a scalable video coding (SVC) method according to an embodiment of the present invention are as follows.

a SVC method enabling spatial resolution to be changed in real time

a signaling method indicating that spatial resolution has changed

a detection method actively detecting a spatial resolution change by a decoder when there is no signaling

a method of extracting a scalable video bitstream in which spatial resolution thereof is changed in real time

a decoding method of a scalable video bitstream whose spatial resolution is changed in real time

a decoding method using a Subordinate Layer Reusing (SLR) technique which performs motion estimation of a bitstream with reference to a key frame of a previous Group of Pictures (GOP) while decoding

a coding method performing intra coding (Only Intra coding: INTRA_BL mode+Intra prediction in cur. layer) of an enhancement layer in order to prevent a error propagation by using the SLR technique

re-determining resolution based on the detected spatial resolution in order to change the resolution of an output image in a decoder

determining a reconstruction layer of a decoder based on the detected spatial resolution

Hereinafter, each feature will be described more fully with reference to the accompanying drawings.

Scalable Video Coding Enabling Spatial Resolution to be Changed in Real Time

FIG. 1 is a flow chart illustrating a scalable video encoding method which generates a bitstream which can be decoded while changing a spatial resolution of the bitstream in real time, according to an embodiment of the present invention.

Referring to FIG. 1, when video is inputted into an encoder (S110), a key frame of Group of Picture (GOP) is designated as an initial point from which the spatial resolution is changed, wherein the key frame corresponds to a location for the spatial resolution to be changed (S120).

The key frame designated as the initial point from which the spatial resolution is changed is decoded with an Instantaneous Decoder Refresh (IDR) frame and an intra frame (S130) and the encoded bitstream is outputted (S140).

The IDR frame can be coded using only spatial redundancy, instead of temporal redundancy and initializes basic information for coding, for example, reference frame buffer and frame number information.

Similarly to the IDR frame, the intra frame can be coded using only spatial redundancy, instead of temporal redundancy. However, the intra frame does not initialize frame or basic information.

In the SVC, a coding is performed in a GOP unit. In this case, motion estimation is performed using a frame in the GOP as a reference frame. This is to provide temporal scalability by Motion compensated Temporal Filtering (MCTF). In the case of the key frame, motion estimation can be performed with reference to the key frame of the previous GOP.

In this case, when the spatial resolution is reduced, frame prior to the frame having the reduced resolution can be used during decoding using the motion estimation and compensation and thus problems do not occur.

However, when the spatial resolution is increased, problems may occur when a frame having increased spatial resolution is decoded by motion estimation and compensation. That is, since the key frame of the previous GOP is decoded only with a small resolution and thus the key frame of the reference frame suitable for the increased resolution of the key frame of the current GOP is not decoded, the frame to be referenced for the motion estimation does not exist.

Therefore, in the present invention, the key frame of the GOP is designated as an initial frame which can change the spatial resolution during decoding and the frame is encoded into the IDR frame and the intra frame.

When the spatial resolution is changed in a GOP unit, the frames in each GOP may have identical spatial resolution and thus a problem that the reference frame is not decoded does not occur. However, in the case of the key frame of the GOP, the key frame of the previous GOP is referenced and thus problems still remain.

Therefore, when the key frame of the GOP is encoded into the intra frame, the current key frame uses the key frames of the previous GOP and thus the motion estimation may not be used.

However, when the bitstream is transmitted with the low spatial resolution from an initial stage, the IDR frame having high-resolution may not be transmitted. In this case, the decoder cannot initialize the buffer list of the reference frame. In order to solve the problem, it is preferable that the IDR frame is transmitted with respect to the image of the spatial resolution having high-resolution at first, or it is signaled in a location where the spatial resolution is increased by using the IDR frame.

Accordingly, the key frame of the GOP which corresponds to the location where the spatial resolution is changed, in particular, the location where the spatial resolution needs to be increased, is designated as the initial point from which the spatial resolution is changed and is encoded into the intra frame and the IDR frame.

In the case of a Coarse Granular Scalability (CGS) layer in the SVC, the method described above may be applied.

When the spatial resolution is changed, the resolution of the decoder needs to be changed to be suitable for the changed resolution. In addition, when a bitstream is encoded into a single-loop decoding mode, the exact output image can be obtained after determining the top layer of the bitstream currently being decoded. Therefore, if the top layer is defined as a reconstruction layer, the reconstruction layer needs to be reset to be suitable for changing the resolution.

Signaling Indicating that the Spatial Resolution is Changed

In current SVC, bitstreams having the same spatial resolution are extracted.

When the spatial resolution is reduced to extract the bitstream, the decoder performs decoding but the decoding result showing reduced resolution is not outputted as an image. This is because of a standard which outputs the decoding result of the layer related to a Sequence Parameter Set (SPS) having the largest value of a sequence parameter set id among the SPSs existing in each spatial resolution of the bitstream.

The higher the spatial resolution of the layer, the higher the value of the dependency id. Therefore, even if the spatial resolution is reduced in the middle of extracting the bitstream, the final decoding result outputs the decoding result of the layer having the high spatial resolution and thus the decoding result of the low spatial resolution is not outputted.

Accordingly, the dependency id related to the layer to be outputted currently should be indicated.

Therefore, in the present invention, a method of generating metadata which is information indicating the SPS having the highest spatial resolution among currently available SPSs, that is, spatial resolution change information, and inserting the meta data prior to a NAL unit where the spatial resolution is changed.

Firstly, the metadata includes valid_seq_parameter_set_id which indicates the sequence parameter set id of the SPS having the highest value of the dependency id among available SPSs.

In the bitstream after the location where the metadata is inserted, SPS having a dependency id higher than a SPS having the dependency id in which seq_parameter_set_id includes valid_seq_parameter_set_id does not exist.

Such metadata can be expressed as a form of Supplemental Enhancement Information (SEI).

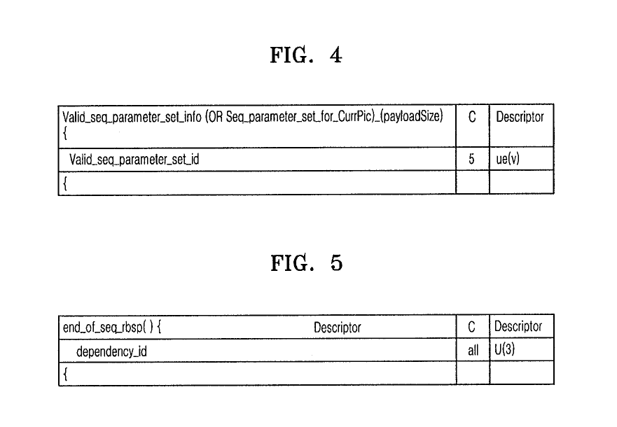

The metadata according to the present invention is illustrated in FIG. 4. Referring to FIG. 4, syntax in the form of SEI referred to as Valid_seq_parameter_set_info (or Seq_parameter_set_for_CurrPic) is inserted prior to the NAL unit of the key frame where the spatial resolution is changed, as the metadata.

In other words, when the spatial resolution is reduced in the bitstream extractor, in order to indicate that the spatial resolution is reduced, the metadata having a value of sequence parameter set id of the SPS indicating the reduced spatial resolution or the SEI referred to as Valid_seq_parameter_set_info (or Seq_parameter_set_for_CurrPic) is inserted just prior to the NAL unit in which the spatial resolution is reduced.

In addition, when the spatial resolution is increased in the bitstream extractor, in order to indicate that the spatial resolution is increased, the metadata having a value of sequence parameter set id of the SPS indicating the increased spatial resolution or the SEI referred to as Valid_seq_parameter_set_info (or Seq_parameter_set_for_CurrPic) is inserted just prior to the NAL unit in which the spatial resolution is increased. However, when the spatial resolution is increased, the SEI can be selectively used, because the case of increasing the spatial resolution occurs just prior to the IDR frame and when the extractor meets the IDR frame, a related SPS is activated.

As another method of indicating spatial resolution change information, a method of using end_of_sequence NAL is used. The end_of_sequence is information indicating that a video sequence is completed. The video sequence is a NAL unit starting from the IDR to just prior to the next IDR. The IDR frame should exist immediately next to the end_of_sequence NAL.

However, when the sequence of a number of layers exists in the SVC, it is unknown which layer is designated. Therefore, the end_of sequence defined in H.264 cannot be used as it is.

Therefore, the syntax changed as illustrated in FIG. 5 is suggested in the present invention. Referring to FIG. 5, dependency_id is included in end_of_sequence, thereby indicating that end_of_sequence is applied with respect to a layer related to a corresponding dependency_id.

In other words, when the spatial resolution of the bitstream is reduced in the bitstream extractor, end_of_sequence, which has dependency id of layers that are not used anymore is inserted just prior to the NAL unit in which spatial resolution is reduced, in order to indicate that the spatial resolution is reduced.

Extracting Scalable Video Bitstream in which Spatial Resolution of Bitstream is Changed in Real Time

In the bitstream extractor, when the spatial resolution is changed, the NAL unit required in decoding each spatial resolution is selected and the remaining NAL unit which is not needed is removed, thereby extracting a bitstream having a desired spatial resolution.

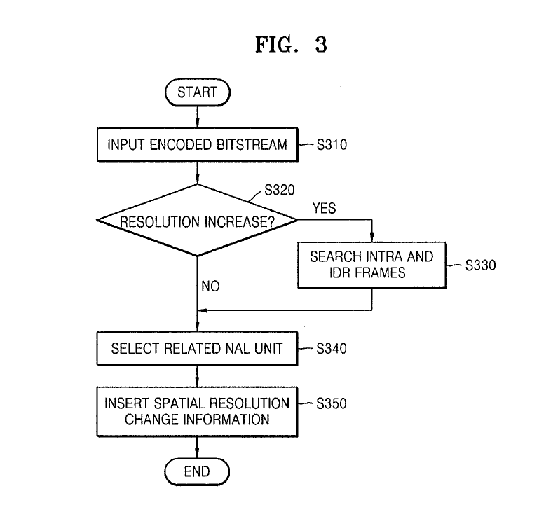

FIG. 3 is a flow chart illustrating a method of extracting a bitstream whose spatial resolution is changed from an encoded scalable video bitstream according to an embodiment of the present invention.

Referring to FIG. 3, when the encoded scalable video bitstream is inputted (S310), a state of spatial resolution change is identified (S320).

When the spatial resolution is desired to be reduced, the NAL unit which is related to the spatial resolution reduced from a temporal position where the spatial resolution is to be reduced is selected (S340).

When the spatial resolution is desired to be increased, the key frame among the key frames dividing a GOP unit of the encoded scalable video stream is designated as the initial point from which the spatial resolution is changed and the key frame encoded by the IDR frame and the intra frame is searched (S330).

Next, the NAL unit related to the increase of the spatial resolution is selected from the key frame obtained by the searching (S340).

The spatial resolution change information is generated to be inserted prior to the searched NAL unit (S350) and the bitstream having changed resolution is extracted. Examples of the spatial resolution change information may be metadata and end_of_sequence having the dependency id of the layers that are not used anymore suggested from the description of “signaling indicating that the spatial resolution is changed” illustrated above.

Decoding Scalable Video Bitstream in which Spatial Resolution of Bitstream is Changed in Real Time

In the decoder, extracted bitstream in which the spatial resolution thereof is changed in real time is decoded. In this case, a basic decoding is same as the existing scalable video decoding method.

In the existing decoder, an image resulted in decoding of the layer related to the SPS having the largest value of the dependency id among the SPS, wherein the SPS exists in each spatial resolution of the bitstream is outputted. The higher the spatial resolution of the layer, the higher the value of the dependency id. Therefore, even if the spatial resolution is reduced in the middle of extracting the bitstream, the final decoding result outputs the decoding result of the layer having the high spatial resolution and thus the image resulted in decoding the low spatial resolution is not outputted.

However, in the decoder of the present invention, the bitstream inputted into the decoder includes additional signaling signal in the bitstream extractor. Therefore, the decoder reads the signaling signal inserted such as the metadata or SEI while decoding and recognizes whether the spatial resolution is reduced or increased, thereby decoding.

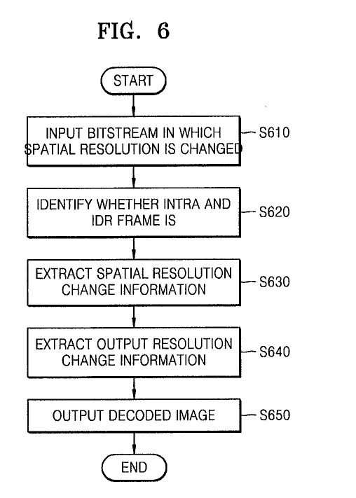

FIG. 6 is a flow chart illustrating a scalable video decoding method which decodes a bitstream by extracting spatial resolution change information, according to an embodiment of the present invention.

Referring to FIG. 6, when the bitstream having changed resolution is inputted (S610), it is identified whether the key frame of the current GOP is designated as the initial point from which the spatial resolution is changed and whether the key frame is encoded by the intra frame and the IDR frame (S620).

In case the key frame is the initial point, the decoder extracts the spatial resolution change information inserted prior to the NAL unit of the key frame (S630). Examples of the spatial resolution change information may be metadata and end_of_sequence having the dependency id of the layers that are not used anymore suggested from the description of “signaling indicating that the spatial resolution is changed” illustrated above.

Next, sequence parameter set id of the SPS which indicates the spatial resolution to be outputted currently through the spatial resolution change information is identified to redetermine the spatial resolution to be decoded (S640) and final decoded image is outputted (S650).

When the spatial resolution is increased simply, the first frame where the spatial resolution is increased is encoded by the intra frame and the IDR frame and thus is encoded for the previous frame not to be needed while decoding.

When there is No Signaling Indicating that the Spatial Resolution is Changed, Actively Detecting Whether the Spatial Resolution is Changed.

Assuming that the extractor does not indicate the fact that the spatial resolution is changed, the decoder should identify from the inputted bitstream whether the spatial resolution is changed of the inputted bitstream.

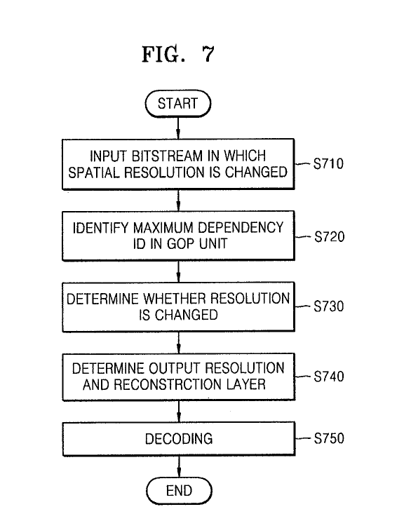

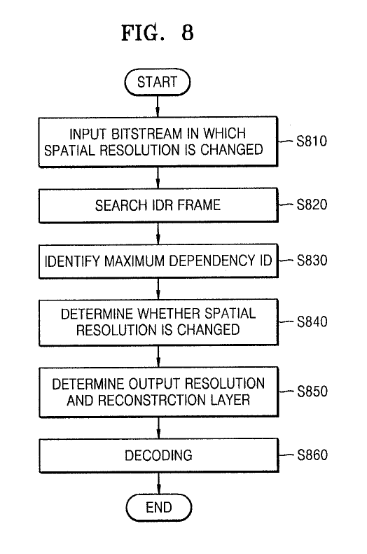

FIGS. 7 and 8 are flow charts illustrating the scalable video decoding method which actively detects whether the spatial resolution is changed so as to decode the bitstream according to an embodiment of the present invention.

When the decoder is JSVM which is currently a standard decoder, whether the spatial resolution is changed can be identified using the max_dependency_id in a GOP unit in the decoder.

When the bitstream having changed spatial resolution is inputted (S710), the max_dependency_id of the current GOP is identified when a key picture of the current GOP is entered, and final decoding level is known (S720).

Then, whether to change the spatial resolution in the current GOP is identified by comparing the max_dependency_id of the current GOP with previously inputted prev_max_dependency_id of the previous GOP (S730).

When it is determined that the spatial resolution is changed, the spatial resolution and the reconstruction layer of the image to be finally outputted are determined from resolution information of the SPS which corresponds to the max_dependency_id of the current GOP that is identified and detected as above (S740).

When the spatial resolution of the image to be finally outputted is determined, the image is decoded and outputted (S750).

Then, when the spatial resolution is changed in an access unit that is formed of the IDR frame in which a random access is available, coding dependency is not affected. In addition, whether to change the spatial resolution can be identified by finding out the value of the dependency id in the access unit that is formed of the IDR frame.

When the bitstream having changed spatial resolution is inputted (S810), the IDR frame in which the random access is available is searched (S820).

In the current access unit which is formed of the IDR frame, the max_dependency_id is identified (S830).

Next, whether to change the spatial resolution in the current access unit is identified by comparing the max_dependency_id of the current access unit with previously inputted prev_max_dependency_id of the previous access unit (S840).

When it is determined that the spatial resolution is changed, the spatial resolution and the reconstruction layer of the image to be finally outputted are determined from resolution information of the SPS which corresponds to the max_dependency_id of the current access unit that is identified and detected as above (S850).

When the spatial resolution of the image to be finally outputted is determined, the image is decoded and outputted (S860).

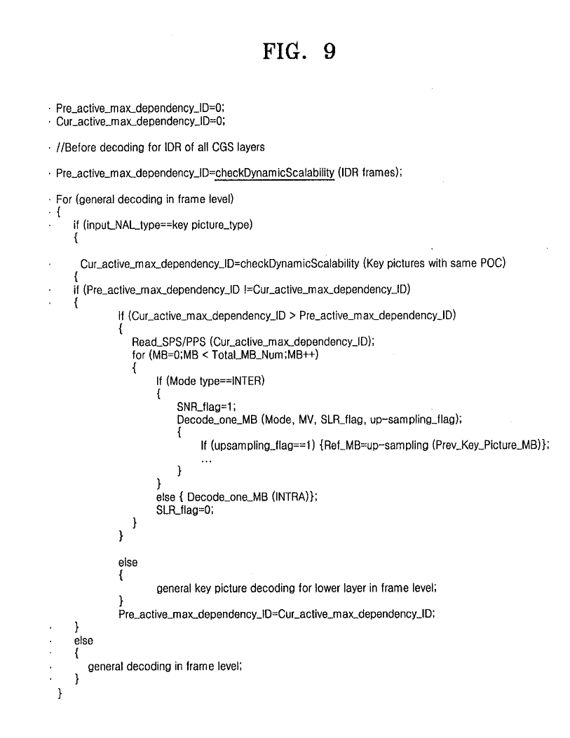

FIG. 9 is a diagram of pseudo code illustrating the scalable video decoding method which actively detects whether the spatial resolution is changed so as to decode the bitstream according to an embodiment of the present invention.

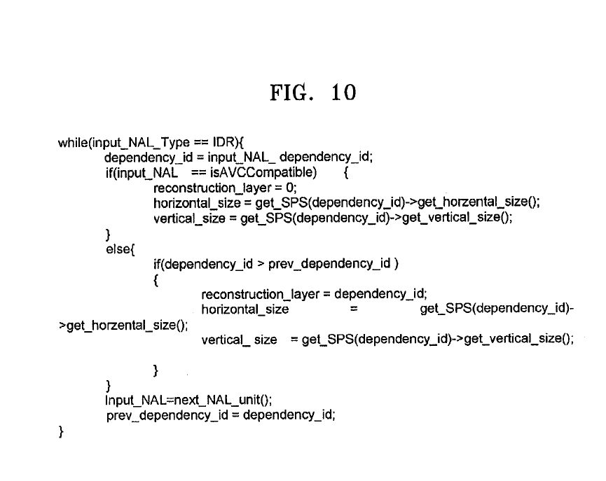

FIG. 10 is a diagram of pseudo code which renews resolution and the reconstruction layer of an output image in the access unit, wherein the access unit includes the IDR frame according to an embodiment of the present invention.

Using a Subordinate Layer Reusing (SLR) Method to Refer to the Key Frame of the Previous GOP During Decoding

When the bitstream is not particularly restricted to the change of the spatial resolution in the encoder, the key frame of the previous GOP is decoded only into the small resolution when the current spatial resolution is increased. Therefore, the key frame of the reference frame suitable for the increased resolution of the key frame of the current GOP is not decoded and thus the reference frame which can be referred for the motion estimation does not exist. In other words, the decoder does not store the reference frame with respect to the key frame of the current GOP having increased spatial resolution. Therefore, in this case, other reference frame is needed to be substituted for the key frame of the previous GOP which is the reference frame.

In the present invention, the key frame of the lower layer of the previous GOP is substituted for the reference frame using the SLR technique and the motion estimation of the current GOP is performed through up-sampling of the frame.

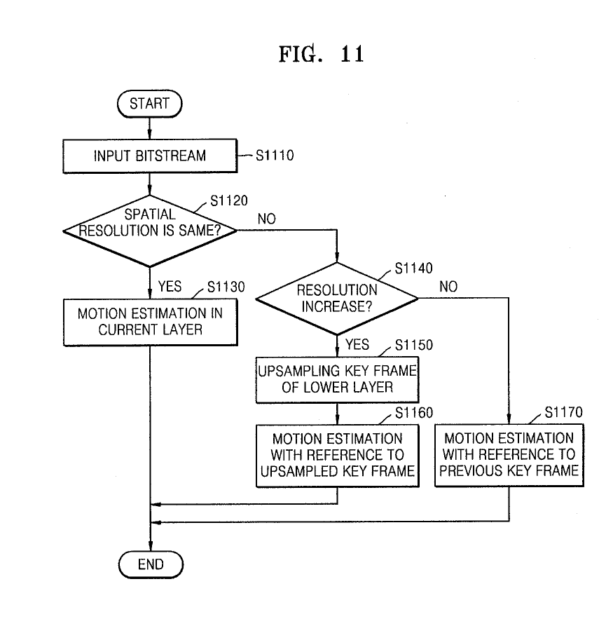

FIG. 11 is a flow chart illustrating a scalable video decoding method illustrating a method of estimating the motion of a bitstream whose a spatial resolution is changed according to an embodiment of the present invention.

FIG. 12 is a conceptual diagram of a decoding method based on the SLR technique according to an embodiment of the present invention.

Referring to FIGS. 11 and 12, when the bitstream is inputted (S1110), the decoder determines whether the resolution of the bitstream has changed. The method of determining whether the resolution of the bitstream has changed may include extracting spatial resolution change information inserted in the bitstream and using the dependency id in a GOP unit, etc.

Firstly, it is determined whether the spatial resolution is same (S1120).

If the spatial resolution is same, the motion estimation is performed with reference to the key frame of the previous GOP inputted previously in the corresponding layer of the current GOP (S1130).

Next, if the spatial resolution is not same, it is determined whether the spatial resolution is increased (S1140).

If the spatial resolution is increased, the key frame of the lower layer which corresponds to the temporally same location with the key frame of the previous GOP is up-sampled (S1150). The previous GOP is in the same layer with the current GOP

The key frame of the current GOP refers to the key frame of the lower layer which was up-sampled and performs the motion estimation to be decoded (S1160).

If the spatial resolution is decreased, the previous frame can be used as the reference frame and thus the motion estimation is performed with reference to the previous key frame previously inputted (S1170).

A conceptual diagram of a decoding method based on the SLR technique according to an embodiment of the present invention is shown in FIG. 12.

Using Only Intra Coding (INTRA_BL Mode+Intra Prediction in Cur. Layer) of an Enhancement Layer to Prevent Error Propagation when Using the SLR

In the SLR technique described above, the key frame of the lower layer of the previous GOP is used instead of the reference frame that is originally needed, and thus noise information is used, wherein the noise information is not included in the original reference frame. If the IDR frame is not periodically generated or a period with respect to the IDR frame lengthens, such noise information may cause error propagation with respect to the whole sequence or numerous frames.

However, assuming that the actual spatial resolution change does not occur many times in the whole sequence, an insertion of the IDR frame in a GOP unit decreases Rate-Distortion (R-D) performance of the whole sequence.

Therefore, if the insertion period of the IDR frame is lengthened and the intra frame is periodically inserted between the period during encoding, error propagation can be prevented. Such restriction of coding increases coding efficiency as compared with the frequent insertion of the IDR frame and additional syntax is not needed to be inserted in the encoder.

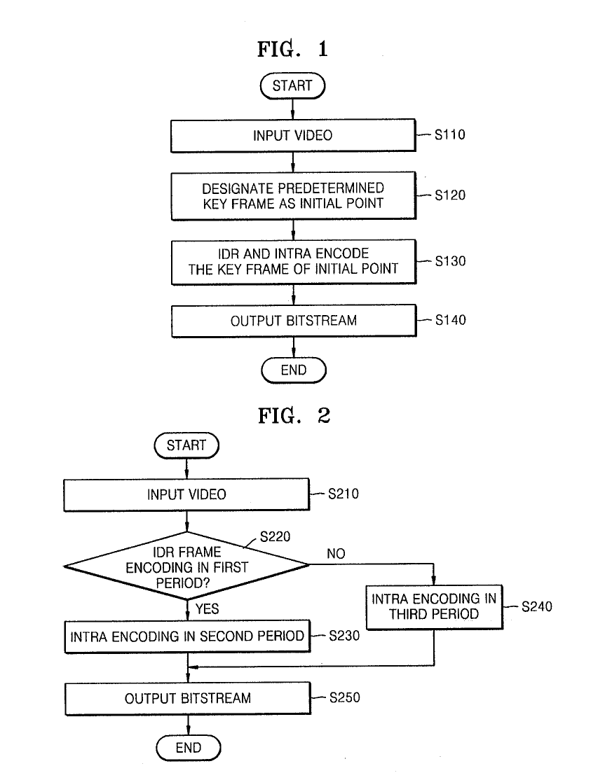

FIG. 2 is a flow chart illustrating a scalable video encoding method according to another embodiment of the present invention.

Referring to FIG. 2, in the case of decoding using the SLR technique, when video is inputted (S210), it is determined whether the frames which correspond to the locations of a predetermined first period are encoded into the IDR frame (S220).

When the video frames are encoded into the IDR frame in the first periodic interval, the frames which correspond to the locations of a second period are encoded into the intra frame in a second periodic interval which is shorter than the first periodic interval (S230) and the coded bitstream is outputted (S250). Therefore, while decoding, the error propagation due to long period of the IDR frame stops due to the intra frame, in which the intra frame does not refer to the frame of the lower layer inserted during the decoding, thereby preventing error propagation.

When the video frames are not encoded into the IDR frame, the frames are encoded into the intra frame in a predetermined third periodic interval (S240) and the encoded bitstream is outputted. Therefore, the error propagation can be prevented due to the intra frame being decoded. The encoded bitstream is outputted in the same manner as described above (S250).

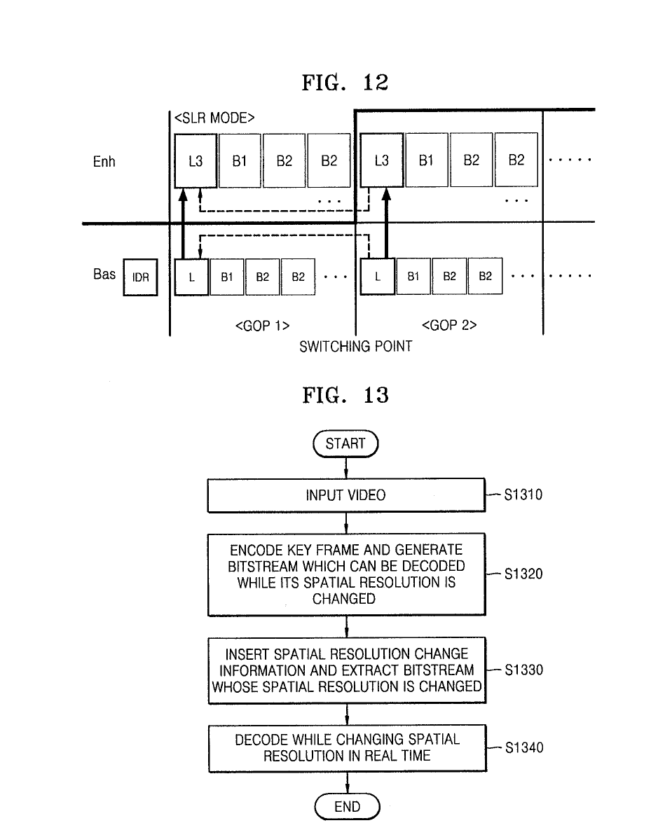

FIG. 13 is a flow chart illustrating a scalable video coding method which can change the spatial resolution of the bitstream in real time according to an embodiment of the present invention.

Referring to FIG. 13, when video is inputted (S1310), the key frame of the GOP which corresponds to the location for the spatial resolution to be changed is designated as the initial point from which the spatial resolution is changed and the designated key frame is encoded into the IDR frame and the intra frame to generate the bitstream which can be decoded while changing the spatial resolution in real time (S1320).

The spatial resolution change information is inserted prior to the NAL unit of the frame in which the spatial resolution thereof is changed in the bitstream above and the bitstream in which the spatial resolution is changed is extracted (S1330). When the spatial resolution is to be reduced, the NAL unit which is related to the reduction of the spatial resolution is selected from the corresponding temporal position. When the spatial resolution is to be increased, the key frame encoded into the IDR frame and the intra frame is searched and the NAL unit which is related to the increase of the spatial resolution is selected from the key frame obtained by the searching, and then the spatial resolution change information is inserted.

Examples of the spatial resolution change information may be metadata and end_of_sequence having the dependency id of the layers that are not used anymore illustrated in the description of “Signaling indicating that the spatial resolution is changed.”

Next, the bitstream is decoded while the spatial resolution is changed in real time based on the spatial resolution change information (S1340). The spatial resolution change information which is inserted prior to the selected NAL unit is extracted and it is determined whether the spatial resolution is increased or reduced during the bitstream decoding.

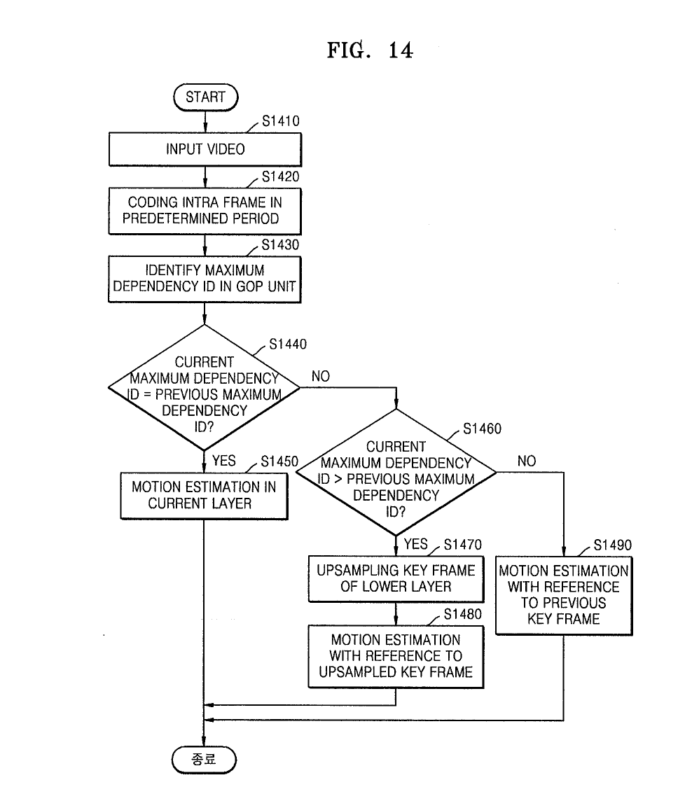

FIG. 14 is a flow chart illustrating a scalable video coding method which can change the spatial resolution of a bitstream in real time by actively detecting whether the resolution has changed, according to an embodiment of the present invention.

Referring to FIG. 14, when video is inputted (S1410), the inputted frames are coded into the intra frame in a predetermined periodic interval to generate the bitstream (S1420). If the inputted frames are also encoded into the IDR frame periodically, it is preferable the periodic interval of the intra frame is shorter than periodic interval of the IDR frame.

In order to determine whether the spatial resolution is changed or not, when the key frame is inputted in a GOP unit, the maximum dependency id is identified (S1430).

Next, to compare the maximum dependency id of the current GOP with the previously inputted maximum dependency id of the previous GOP, it is firstly determined whether the value of the current maximum dependency id is same with the value of the previous maximum dependency id (S1440).

If the value of the current maximum dependency id is same with the value of the previous maximum dependency id, the motion estimation is performed with reference to the key frame of the previous GOP inputted prior to the corresponding layer of the current GOP (S1450).

If the value of the current maximum dependency id is not same with the value of the previous maximum dependency id, whether the value of the current maximum dependency id is larger than the value of the previous maximum dependency id is identified (S1460).

If the value of the current maximum dependency id is larger than the value of the previous maximum dependency id, it is determined that the spatial resolution of the GOP is increased and the key frame of the lower layer corresponding to the temporally identical location with the key frame of the previous GOP inputted prior to the same layer of the current GOP is up-sampled (S1470).

The key frame of the current GOP performs the motion estimation with reference to the key frame of the lower layer that is up-sampled and is decoded (S1480).

If the value of the current maximum dependency id is smaller than the value of the previous maximum dependency id, it is determined that the spatial resolution of the GOP is reduced and the motion estimation is performed with reference to the key frame of the previous GOP to decode (S1490).

FIG. 15 is a block diagram of a scalable video encoder according to an embodiment of the present invention.

Referring to FIG. 15, an encoder 1500 which changes the spatial resolution in real time and generates the bitstream enabling to decode includes a point designating unit 1510 and an encoding unit 1520.

The point designating unit 1510 designates the key frame of the GOP corresponding to the location for the spatial resolution to be changed as the initial point from which the spatial resolution is changed.

The encoding unit 1520 encodes the key frame that is designated as the initial point into the IDR frame and the intra frame and generates the coded bitstream.

In addition, if the encoder 1500 is not limited to encoding without the motion estimation after the initial point is particularly designated, the encoding unit 1520 can encode the frames inputted in a GOP unit into the IDR frame or the intra frame in a predetermined period to prevent an error propagation during decoding by using the SLR technique in the decoder. In other words, to prevent error propagation, when the IDR frame is not inserted into the increased layer or the IDR frame is used, the frames are encoded into the intra frame in a shorter periodic interval than the period of the IDR frame after considering R-D performance of the whole video sequence.

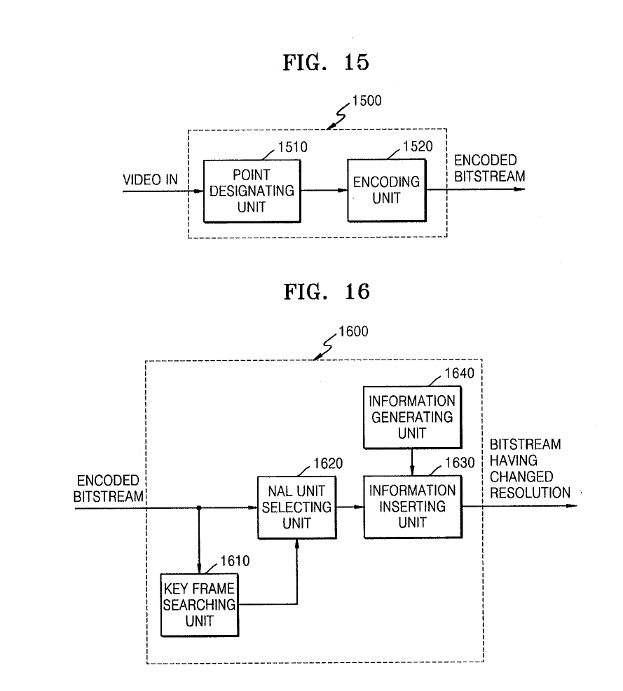

FIG. 16 is a block diagram of an extractor which extracts from a coded bitstream a bitstream whose resolution is changed, according to an embodiment of the present invention.

Referring to FIG. 16, an extractor 1600 includes a key frame searching unit 1610, a NAL unit selecting unit 1620, an information inserting unit 1630, and an information generating unit 1640.

In order for the spatial resolution to be increased, when the encoded scalable video bitstream is inputted, the key frame searching unit 1610 searches the key frame is designated as an initial point of spatial resolution changing among the key frames discriminating each GOP, and coded into the IDR frame and the intra frame.

In order for the spatial resolution to be increased, the NAL unit selecting unit 1620 selects the NAL unit which is related to increase of the spatial resolution. In order for the spatial resolution to be reduced, the NAL unit selecting unit 1620 selects the related NAL unit from the temporal location for the spatial resolution to be reduced.

The information inserting unit 1630 generates spatial resolution change information and inserts the information prior to the NAL unit which is related to increase or reduction of the spatial resolution.

The spatial resolution change information may be generated by an additional information generating unit 1640 to be inserted. Examples of the spatial resolution change information may be metadata and end_of_sequence having the dependency id of the layers that are not used anymore suggested from the description of “signaling indicating that the spatial resolution is changed” illustrated above.

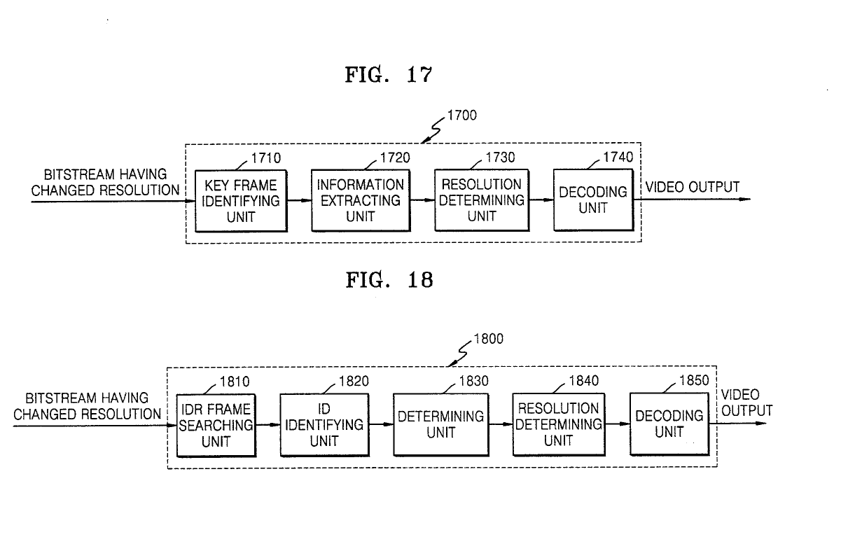

FIG. 17 is a block diagram of a scalable video decoder which extracts spatial resolution change information from the bitstream whose resolution is changed, so as to decode the bitstream according to an embodiment of the present invention.

Referring to FIG. 17, a decoder 1700 includes a key frame identifying unit 1710, an information extracting unit 1720, a resolution determining unit 1730, and a decoding unit 1740.

The key frame identifying unit 1710 identifies whether the key frame of the currently inputted GOP is designated as an initial point of spatial resolution changing and whether the key frame is coded into the intra frame and the IDR frame.

If the key frame is intra frame and the IDR frame, the information extracting unit 1720 extracts the spatial resolution change information inserted prior to the NAL unit of the key frame. Examples of the spatial resolution change information may be metadata and end_of_sequence having the dependency id of the layers that are not used anymore suggested from the description of “signaling indicating that the spatial resolution is changed” illustrated above.

The resolution determining unit 1730 determines spatial resolution and a reconstruction layer of an image to be outputted from the spatial resolution change information. The dependency id included in the spatial resolution change information is identified and thus the resolution of the image to be finally outputted can be determined using resolution information of the SPS corresponding to the dependency id.

When the spatial resolution of the image to be outputted is determined, the decoding unit 1740 performs decoding.

FIG. 18 is a block diagram of a scalable video decoder which actively detects whether the spatial resolution has changed in the bitstream so as to decode the bitstream according to an embodiment of the present invention.

Referring to FIG. 18, a decoder 1800 which actively detects whether resolution is changed or not, when the spatial resolution change information is not inserted into the bitstream, includes an IDR frame searching unit 1810, an id identifying unit 1820, a determining unit 1830, a resolution determining unit 1840, and a decoding unit 1850.

The IDR frame searching unit 1810 searches the IDR frame which is to be a point of a random access in the bitstream inputted in a GOP unit.

The id identifying unit 1820 identifies the maximum dependency id of the current access unit formed of the IDR frame.

The determining unit 1830 compares the maximum dependency id of the current access unit with the maximum dependency id of the access unit formed of the previously inputted IDR frame and determines whether the spatial resolution of the current access unit is changed.

When it is determined that the spatial resolution is changed, the resolution determining unit 1840 determines the changed spatial resolution and the reconstruction layer related to the spatial resolution of the image to be outputted from the resolution information of the SPS which correspond to the maximum dependency id of the current access unit.

When the spatial resolution of the image to be outputted is determined, the decoding unit 1850 performs decoding.

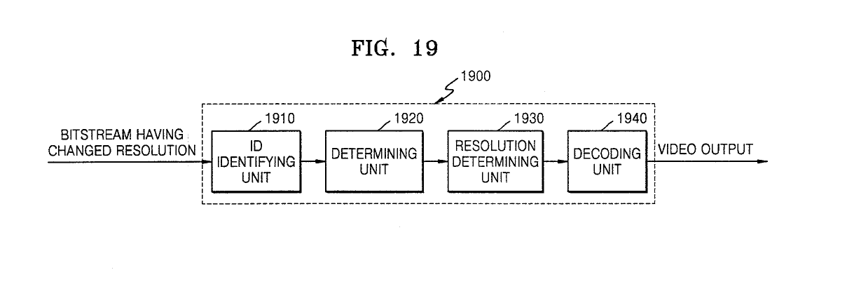

FIG. 19 is a block diagram of a scalable video decoder which actively detects whether the resolution is changed in the bitstream, so as to decode the bitstream according to another embodiment of the present invention.

Referring to FIG. 19, a decoder 1900 which actively detects whether resolution is changed or not, when the spatial resolution change information is not inserted into the bitstream, includes an id identifying unit 1910, a determining unit 1920, a resolution determining unit 1930, and a decoding unit 1940.

The id identifying unit 1910 identifies the maximum dependency id of the currently inputted GOP.

The determining unit 1920 compares the maximum dependency id of the current GOP with the maximum dependency id of the previous GOP and determines whether the spatial resolution of the current GOP is changed.

When it is determined that the spatial resolution is changed, the resolution determining unit 1930 determines the changed spatial resolution and the reconstruction layer related to the spatial resolution of the image to be outputted from the resolution information of the SPS which corresponds to the maximum dependency id of the current GOP.

When the spatial resolution of the image to be outputted is determined, the decoding unit 1940 performs decoding.

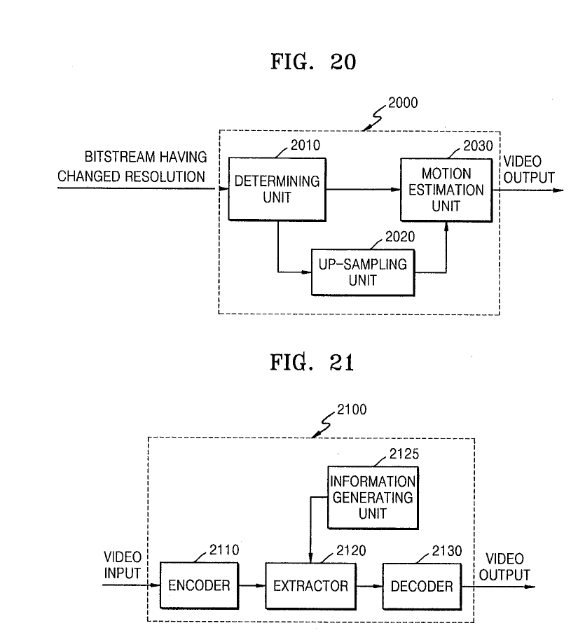

FIG. 20 is a block diagram of a scalable video decoder which decodes the bitstream using the SLR technique according to an embodiment of the present invention.

A decoder 2000 includes a determining unit 2010, an up-sampling unit 2020, and a motion estimation unit 2030.

The determining unit 2010 determines whether the spatial resolution of the currently inputted GOP is changed. After the dependency id of the corresponding GOP is identified, whether to change the resolution can be known according to change of the value of the id.

When it is determined that the spatial resolution is changed, the up-sampling unit 2020 up-samples the key frame of the lower layer which corresponds to the temporally identical location with the key frame of the previous GOP inputted prior to the same layer of the current GOP.

In the motion estimation unit 2030, the motion estimation of the key frame of the current GOP is performed with reference to the key frame of the lower layer which is up-sampled. If the spatial resolution is reduced, the motion estimation is performed with reference to the key frame of the previously inputted GOP and if the spatial resolution is not changed, the motion estimation is performed with reference to the key frame of the previous GOP of the same layer.

FIG. 21 is a block diagram of a codec enabling the spatial resolution of the bitstream to be changed in real time according to an embodiment of the present invention.

Referring to FIG. 21, a codec 2100 includes an encoder 2110, an information generating unit 2125, an extractor 2120, and a decoder 2130.

The encoder 2110 generates a scalable video bitstream which can change the spatial resolution to be decoded in real time with respect to the inputted video.

The key frame of the GOP which corresponds to the location for the spatial resolution to be changed is designated as an initial point of spatial resolution changing and is coded into the IDR frame and intra frame.

In addition, if the restriction to the key frame does not exist, the frames located in a predetermined periodic interval among frames inputted in a GOP unit are encoded into the IDR frame and/or intra frame in the predetermined periodic interval. When the frames are coded into the IDR frame and intra frame, it is preferable the period of the intra frame is shorter than the period of the IDR frame. Since the motion estimation is performed during decoding in the decoder with reference to the key frame of the lower layer using the SLR technique, error propagation can be adequately prevented.

The extractor 2120 extracts the bitstream in which the spatial resolution thereof is changed in the encoded scalable video bitstream.

In the bitstream, the key frame coded into the IDR frame and the intra frame is searched and the spatial resolution change information is inserted prior to the NAL unit of the key frame obtained by the searching to extract the bitstream whose spatial resolution is changed. Therefore, the spatial resolution change information can be extracted and decoded by the decoder.

The extractor 2120 may extract the bitstream without additionally inserting the spatial resolution change information. In this case, information on whether to change the spatial resolution can be directly extracted by the decoder.

Examples of the spatial resolution change information may be metadata and end_of_sequence having the dependency id of the layers that are not used anymore suggested from the description of “signaling indicating that the spatial resolution is changed” illustrated above. In addition, the spatial resolution change information may be generated by the information generating unit 2125.

The decoder 2130 changes the spatial resolution of the extracted scalable video bitstream in real time to be decoded.

In addition, when the extractor 2120 does not insert the spatial resolution change information, the decoder 2130 can actively detect whether the spatial resolution is changed using the dependency id in the bitstream. If it is determined that the spatial resolution is increased, the key frame of the GOP in which the spatial resolution is increased performs the motion estimation with reference to the key frame of the lower layer to be decoded.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer system so that the computer readable code is stored and executed in a distributed fashion. Also, functional programs, codes, and code segments for accomplishing the present invention can be easily construed by programmers skilled in the art to which the present invention pertains.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A scalable video encoding method for performing a motion estimation to each key frame which distinguishes each of Groups of Pictures (GOPs) with reference to a key frame previously inputted and for generating a bitstream which can be decoded while a spatial resolution is changed in real time, the method comprising:
designating the key frame of the GOP which corresponds to a location at which the spatial resolution is to be changed as an initial point from which spatial resolution is changed; and
encoding the key frame that is designated as the initial point into an IDR frame and intra frame.

2. A scalable video encoding method for performing a motion estimation to each key frame which distinguishes each of Groups of Pictures (GOPs) with reference to a key frame previously inputted and for generating a bitstream which can be decoded while a spatial resolution is changed in real time, the method comprising:
when the frames inputted in a GOP unit are encoded into the IDR frame in a first periodic interval, encoding the frames into the intra frame in a second periodic interval which is shorter than the first periodic interval; and
when the frames inputted in a GOP unit are not encoded into the IDR frame in a first periodic interval, encoding the frames into the intra frame in a third periodic interval.

3. A method of extracting from an encoded scalable bitstream a scalable video bitstream whose spatial resolution is changed, the method comprising:
when the spatial resolution is to be reduced, selecting a NAL unit which is related to reduction of the spatial resolution from the corresponding temporal location;
when the spatial resolution is to be increased, searching the key frame which is designated as an initial point from which spatial resolution is changed among key frames which distinguish each of GOPs of the encoded scalable video bitstream and coded into an IDR frame and an intra frame; and
selecting a NAL unit which is related to an increase of the spatial resolution from the key frame obtained by the searching.

4. The method of claim 3, further comprising generating spatial resolution change information to be inserted prior to the selected NAL unit.

5. The method of claim 4, wherein the spatial resolution change information comprises a sequence parameter set id of a Sequence Parameter Set (SPS) which corresponds to the maximum dependency id in the bitstream after the key frame obtained by the searching.

6. The method of claim 4, wherein the spatial resolution change information indicates that a video sequence having a previous spatial resolution which is not yet changed is completed, wherein the video sequence is a series of the NAL units from one IDR frame to a frame prior to the next IDR frame.

7. The method of claim 6, wherein the information indicating that the video sequence is completed includes a dependency id of a layer which corresponds to the previous spatial resolution which is not yet changed.

8. A scalable video decoding method for performing a motion estimation to each key frame which distinguishes each of Groups of Pictures (GOPs) with reference to a key frame previously inputted and for decoding a bitstream while changing a spatial resolution in real time, the method comprising:
identifying whether a key frame of currently inputted GOP is designated as an initial point from which spatial resolution is changed and whether the key frame is encoded into an intra frame and IDR frame;
when the key frame is the intra frame and the IDR frame, extracting spatial resolution change information inserted prior to a NAL unit of the key frame that is designated as the initial point; and
determining the spatial resolution to be outputted from the spatial resolution change information.

9. The method of claim 8, wherein the spatial resolution change information comprises a sequence parameter set id of a Sequence Parameter Set (SPS) which corresponds to the maximum dependency id in the bitstream after the key frame designated as the initial point.

10. The method of claim 8, wherein the spatial resolution change information indicates that a video sequence having a previous spatial resolution which is not yet changed is completed, wherein the video sequence is a series of the NAL units from one IDR frame to a frame prior to the next IDR frame.

11. A scalable video decoding method for performing a motion estimation to each key frame which distinguishes each of Groups of Pictures (GOPs) with reference to a previously inputted key frame and for decoding a bitstream while changing a spatial resolution in real time, the method comprising:
searching an IDR frame in the bitstream inputted in a GOP unit;
identifying the maximum dependency id of a current access unit formed of the IDR frame; and
comparing the maximum dependency id of the current access unit with the maximum dependency id of a previous access unit formed of the IDR frame to determine whether the spatial resolution of the current access unit is changed.

12. The method of claim 11, further comprising determining the spatial resolution of an image to be finally outputted from resolution information of a Sequence Parameter Set (SPS) which corresponds to the maximum dependency id of the current access unit, when it is determined that the spatial resolution of the current access unit has changed.

13. The method of claim 11, further comprising determining a reconstruction layer related to the spatial resolution of an image to be finally outputted from resolution information of the SPS which corresponds to the maximum dependency id of the current access unit, when it is determined that the spatial resolution of the current access unit has changed.

14. A scalable video decoding method for performing a motion estimation to each key frame which distinguishes each of Groups of Pictures (GOPs) with reference to a previously inputted key frame and for decoding a bitstream while changing a spatial resolution in real time, the method comprising:
identifying the maximum dependency id of currently inputted GOP; and
comparing the maximum dependency id of the current GOP with the maximum dependency id of previous GOP to determine whether the spatial resolution of the current GOP is changed.

15. The method of claim 14, further comprising determining the spatial resolution of an image to be finally outputted from resolution information of a Sequence Parameter Set (SPS) which corresponds to the maximum dependency id of the current GOP, when it is determined that the spatial resolution of the current GOP has changed.

16. The method of claim 14, further comprising determining a reconstruction layer related to the spatial resolution of an image to be finally outputted from resolution information of the SPS which corresponds to the maximum dependency id of the current GOP, when it is determined that the spatial resolution of the current access unit has changed.

17. A scalable video decoding method for performing a motion estimation to each key frame which distinguishes each of Groups of Pictures (GOPs) with reference to a previously inputted key frame and for decoding a bitstream while changing a spatial resolution in real time, the method comprising:
determining whether the spatial resolution of a GOP currently inputted is changed;
when the spatial resolution of the current GOP is increased, up-sampling the key frame of a lower layer which corresponds to a temporally identical location with the key frame of a GOP previously inputted of the layer which is same with layer of the current GOP; and
performing the motion estimation by the key frame of the current GOP with reference to the key frame of the lower layer that is up-sampled.

18. A scalable video coding method for performing a motion estimation to each key frame which distinguishes each of Groups of Pictures (GOPs) with reference to a previously inputted key frame, the method comprising:
designating the key frame of the GOP which corresponds to a location for a spatial resolution to be changed as an initial point of the spatial resolution changing and encoding the key frame into an IDR frame and intra frame to generate a bitstream which can be decoded while the spatial resolution is changed in real time;
inserting spatial resolution change information prior to a NAL unit of the frame in which the spatial resolution is changed in the bitstream and extracting the bitstream whose spatial resolution is changed; and
decoding the bitstream whose spatial resolution is changed while the spatial resolution is changed in real time based on the spatial resolution change information.

19. The method of claim 18, wherein extracting the bitstream comprising:
when the spatial resolution is to be reduced, selecting a NAL unit which relates to reduction of the spatial resolution from corresponding temporal location;
when the spatial resolution is to be increased, searching the key frame encoded into the IDR frame and the intra frame and selecting the NAL unit which relates to increase of the spatial resolution from the key frame obtained by the searching; and
generating the spatial resolution change information to be inserted prior to the selected NAL unit.

20. The method of claim 18, wherein the spatial resolution change information comprises sequence parameter set id of a Sequence Parameter Set (SPS) which corresponds to the maximum dependency id in the bitstream after the key frame designated as an initial point.

21. The method of claim 18, wherein the spatial resolution change information indicates that a video sequence having a previous spatial resolution which is not yet changed is completed, wherein the video sequence is a series of the NAL units from one IDR frame to a frame prior to the next IDR frame.

22. A scalable video coding method for performing a motion estimation to each key frame which distinguishes each of Groups of Pictures (GOPs) with reference to a previously inputted key frame, the method comprising:
encoding the frames inputted in a GOP unit into an intra frame in a predetermined periodic interval and generating a bitstream;
identifying the maximum dependency id of each GOP in the encoded bitstream to detect whether spatial resolution is changed; and
when it is determined that the spatial resolution is increased, decoding the key frame of the GOP in which the spatial resolution is increased with reference to the key frame of a lower layer.

23. The method of claim 22, wherein generating the bitstream comprising:
when the frames inputted in a GOP unit are encoded into an IDR frame in a first periodic interval, encoding the frames into the intra frame in a second periodic interval which is shorter than the first periodic interval; and
when the frames inputted in a GOP unit are not encoded into the IDR frame in a first periodic interval, encoding the frames into the intra frame in a third periodic interval.

24. The method of claim 22, wherein detecting comprising:
identifying the maximum dependency id of a GOP currently inputted in the encoded bitstream; and
comparing the maximum dependency id of the current GOP with the maximum dependency id of a GOP previously inputted to determine whether the spatial resolution of the current GOP is changed.

25. The method of claim 22, wherein decoding comprising:
when the spatial resolution of currently inputted GOP is increased, up-sampling the key frame of a lower layer which corresponds to a temporally identical location with the key frame of previously inputted GOP of the layer which is same with that of the current GOP; and
performing the motion estimation by the key frame of the current GOP with reference to the key frame of the lower layer that is up-sampled.

26. A scalable video encoder to perform a motion estimation to each key frame which distinguishes each of Groups of Pictures (GOPs) by with reference to a previously inputted key frame and to generate a bitstream which can be decoded while a spatial resolution is changed in real time, the encoder comprising:
a point designating unit which designates the key frame of the GOP which corresponds to a location at which the spatial resolution is changed as an initial point from which spatial resolution is changed; and
an encoding unit which encodes the key frame that is designated as the initial point into an IDR frame and intra frame.

27. A scalable video encoder to perform a motion estimation to each key frame which distinguishes each of Groups of Pictures (GOPs) with reference to a previously inputted key frame and to generate a bitstream which can be decoded while a spatial resolution is changed in real time, the encoder comprising:
an encoding unit which encodes the frames inputted in a GOP unit into an intra frame in a second periodic interval which is shorter than a first periodic interval, when the frames inputted in a GOP unit are encoded into an IDR frame in the first periodic interval, and which encodes the frames inputted in a GOP unit into an intra frame in a third periodic interval, when the frames inputted in a GOP unit are not encoded into the IDR frame in a first periodic interval.

28. A bitstream extractor to extract a bitstream whose spatial resolution is changed in a encoded scalable video bitstream, the extractor comprising:
a key frame searching unit which searches the key frame designated as an initial point from which spatial resolution is changed among the key frames distinguishing each GOP in the encoded scalable video bitstream and encoded into an IDR frame and intra frame, when the spatial resolution is to be increased; and
a NAL unit selecting unit which selects the NAL unit which is related to increase of the spatial resolution from the key frame obtained by the searching and selects the NAL unit which is related to reduction of the spatial resolution from a corresponding temporal location when the spatial resolution is to be reduced.

29. The extractor of claims 28, further comprising an information inserting unit which generates spatial resolution change information to be inserted prior to the selected NAL unit.

30. The extractor of claim 29, wherein the spatial resolution change information comprises sequence parameter set id of a Sequence Parameter Set (SPS) which corresponds to the maximum dependency id in the bitstream after the key frame obtained by the searching.

31. The extractor of claim 29, wherein the spatial resolution change information indicates that a video sequence having a previous spatial resolution which is not yet changed is completed, wherein the video sequence is a series of the NAL units from one IDR frame to a frame prior to the next IDR frame.

32. A scalable video decoder to perform a motion estimation to each key frame which distinguishes each of Groups of Pictures (GOPs) with reference to a previously inputted key frame and to decode a bitstream while changing a spatial resolution in real time, the decoder comprising:
a key frame identifying unit which identifies whether the key frame of the GOP currently inputted is designated as an initial point from which spatial resolution is changed and whether the key frame is coded into an intra frame and IDR frame;
an information extracting unit which extracts spatial resolution change information inserted prior to a NAL unit of the key frame designated as the initial point, when the key frame is the intra frame and the IDR frame; and
a resolution determining unit which determines the spatial resolution to be outputted from the spatial resolution change information.

33. A scalable video decoder to perform a motion estimation to each key frame which distinguishes each of Groups of Pictures (GOPs) with reference to a previously inputted key frame and to decode a bitstream while changing a spatial resolution in real time, the decoder comprising:
a key frame searching unit which searches an IDR frame in the bitstream inputted in a GOP unit;
an id identifying unit which identifies the maximum dependency id of the current access unit formed of the IDR frame; and
a determining unit which compares the maximum dependency id of the current access unit with the maximum dependency id of the access unit formed of the previously inputted IDR frame and determines whether the spatial resolution of the current access unit is changed.

34. The decoder of claim 33, further comprising a resolution determining unit which determines spatial resolution and a reconstruction layer related to the spatial resolution of an image to be finally outputted from resolution information of a Sequence Parameter Set (SPS) which corresponds to the maximum dependency id of the current access unit, when it is determined that the spatial resolution of the current access unit is changed.

35. A scalable video decoder to perform a motion estimation to each key frame which distinguishes each of Groups of Pictures (GOPs) with reference to a previously inputted key frame, the decoder comprising:
an id identifying unit which identifies the maximum dependency id of a GOP currently inputted; and
a determining unit which compares the maximum dependency id of the current GOP with the maximum dependency id of the previous GOP and determines whether the spatial resolution of the current GOP is changed.

36. The decoder of claim 35, further comprising a resolution determining unit which determines spatial resolution and a reconstruction layer related to the spatial resolution of an image to be finally outputted from resolution information of a Sequence Parameter Set (SPS) which corresponds to the maximum dependency id of the current GOP, when it is determined that the spatial resolution of the current GOP is changed.

37. A scalable video decoder to perform a motion estimation to each key frame which distinguishes each of Groups of Pictures (GOPs) with reference to a previously inputted key frame, the decoder comprising:
a determining unit which determines whether the spatial resolution of a GOP currently inputted is changed;
an up-sampling unit which up-samples the key frame of a lower layer which corresponds to a temporally identical location with the key frame of the previous GOP of the layer which is same with the layer of the current GOP; and
a motion estimation unit in which the motion estimation is performed by the key frame of the current GOP with reference to the key frame of the lower layer that is up-sampled.

38. A scalable video codec to perform a motion estimation to each key frame which distinguishes each of Groups of Pictures (GOPs) with reference to a previously inputted key frame, the codec comprising:
an encoder which designates the key frame of the GOP corresponding to a location for the spatial resolution to be changed as an initial point from which spatial resolution is changed, encodes the key frame into an IDR frame and intra frame, and generates the bitstream so that the bitstream can be decoded while a spatial resolution is changed in real time;
a bitstream extractor which extracts the bitstream in which the spatial resolution is changed while inserting the spatial resolution change information prior to a NAL unit of the frame in which the spatial resolution is changed in the bitstream; and
a decoder which decodes the bitstream in which the spatial resolution is changed while a spatial resolution of the bitstream is changed in real time based on spatial resolution change information.

39. The codec of claim 38, wherein the bitstream extractor comprising:
a key frame searching unit which searches the key frame designated as an initial point from which spatial resolution is changed among the key frames distinguishing each GOP in the encoded scalable video bitstream and coded into an IDR frame and an intra frame, when the spatial resolution is to be increased;
a NAL unit selecting unit which selects the NAL unit which is related to increase of the spatial resolution from the key frame obtained by the searching and selects the NAL unit which is related to reduction of the spatial resolution from a corresponding temporal location when the spatial resolution is to be reduced; and
an information inserting unit which generates spatial resolution change information and inserts the information prior to the selected NAL unit.

40. The codec of claim 38, wherein the spatial resolution change information comprises sequence parameter set id of a Sequence Parameter Set (SPS) which corresponds to the maximum dependency id in the bitstream after the key frame is designated as the initial point.

41. The codec of claim 38, wherein the spatial resolution change information indicates that a video sequence having a previous spatial resolution which is not yet changed is completed, wherein the video sequence is a series of the NAL units from one IDR frame to a frame prior to the next IDR frame.

42. A scalable video codec to perform a motion estimation to each key frame which distinguishes each of Groups of Pictures (GOPs) with reference to a previously inputted key frame, the codec comprising:
an encoder which encodes a frames inputted in a GOP unit into an intra frame in a predetermined periodic interval and generates a bitstream;
a resolution change detecting unit which identifies the maximum dependency id in a GOP unit in the encoded bitstream to detect whether the spatial resolution is changed; and
a decoder which decodes the key frame of the GOP in which the spatial resolution is increased with reference to a key frame of a lower layer, when it is determined that the spatial resolution is increased.

43. The codec of claim 42, wherein the encoder encodes the frames into the intra frame in a second periodic interval which is shorter than the first periodic interval when the frames inputted in a GOP unit are encoded into an IDR frame in the first periodic interval and encodes the frames into the intra frame in a third periodic interval when the frames inputted in a GOP unit are not encoded into the IDR frame in a first periodic interval.

44. The codec of claim 42, wherein the resolution change detecting unit comprising:
an id identifying unit which identifies the maximum dependency id of the GOP currently inputted in the encoded bitstream; and
a determining unit which compares the maximum dependency id of the current GOP with the maximum dependency id of the previous GOP and determines whether the spatial resolution of the current GOP is changed.

45. The codec of claim 42, wherein the decoder comprising:
an up-sampling unit which up-samples the key frame of a lower layer which corresponds to a temporally identical location with the key frame of the previous GOP of the layer which is same with the layer of the current GOP, when the spatial resolution of the currently inputted GOP is increased; and
a motion estimation unit in which the motion estimation is performed by the key frame of the current GOP with reference to the key frame of the lower layer that is up-sampled.

46. A computer readable medium having embodied thereon a computer program for the method of any one of claims 1 through 25.
